(19) United States
(12) Patent Application Publication
(10) Pub. No.: US 2005/0070153 A1
(43) Pub. Date: Mar. 31, 2005

(54) Cable assembly

(76) Inventor: Ye Tang, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/951,506

(22) Filed: Sep. 27, 2004

(30) Foreign Application Priority Data
Sep. 26, 2003 (TW) 92126621

(51) Int. Cl. H01R 11/00

(52) U.S. Cl. 439/502

(57) ABSTRACT

A cable assembly (1) for data transmission includes a first connector (10) connected with a USB port of a personal computer (2), a second connector (20) connected with an audio jack of a mobile phone (3), a cable (30) connecting the first connector and the second connector, and a converting module (40). The first connector includes a pair of upper and lower shells (12) and (13) and defines an accepting space for accommodating the converting module therein. The converting module is provided for converting data formats between the USB port of the first electrical device and the audio jack of the second electrical device.

### BACKGROUND OF THE INVENTION

1. Field of the Invention

The present invention relates generally to a cable assembly, and more particularly to a cable assembly for data transmission between a USB port of a first electrical device and a second electrical device.

2. Description of the Prior Art

In nowadays, Universal Serial Bus (USB) is enjoying broad adoption in the marketplace. According to August data from DataQuest, the USB installed base of USB-capable PCs will grow from a mere 6 million PCs in 1996 to over 700 million by the end of 2003. USB provides for ease of use, expandability, and speed for the end user. USB provides a function for connecting a device in the tree structure, a function for supporting two transmission speeds of 12 megabits per second and 1.5 megabits per second, a function for supporting Plug and Play (PnP), a function for supplying power to a connected device, and a function for supporting hot plug (which enables to connect and disconnect with a running PC).

According to a variety of purposes of USB, many types of USB cables come into the market. For example, there are many kinds of USB cables for charging a battery of an external electrical device using the power supplied by a USB port of a PC or for data transmission between a PC and an external electrical device, for example, a printer, a scanner, a mobile phone and the like.

A USB cable assembly mainly for charging the battery of an external electrical device is disclosed in U.S. Pat. No. 6,211,649. According to the prior art, the USB cable assembly comprises a first connector for connecting with a USB port of a personal computer (PC), a second connector for connecting with a charger port of an external apparatus, a cable connecting the first connector and the second connector, and a control unit, which is situated between the first connector and the second connector, for charging a battery of the external apparatus by using power supplied from the USB port. However, because the control unit of the prior art settles in the middle of the cable, the cable assembly comprises three individual block-bodies which are respectively the first connector, the second connector and the control unit received in an additional case, which results in a complex structure, a complicate manufacture process, and a high cost of the cable assembly. Moreover, if the cable assembly electrically connected between the PC and the external apparatus, the middle control unit is possibly placed just on the floor and easy to be damaged by unexpected external force. Additionally, the second connector of the prior art is a charger connector, which cannot match other special requirements of external apparatus. For example, some mobile phones are designed with an audio jack, and therefore needs a data cable assembly, which comprises a USB port in one end and an audio plug in the other end, for data transmission.

Hence, synthetically consider the factors of configuration, cost, usage and matching with electrical devices etc, an new cable assembly is desired to overcome the above-mentioned disadvantages of the prior art.

### BRIEF SUMMARY OF THE INVENTION

A primary object, therefore, of the present invention is to provide a simple and compact cable assembly for data transmission between a first electrical device and a second electrical device.

In order to implement the above objects and overcomes the above-identified deficiencies in the prior art, the serial data cable of the present invention comprises a first connector connected with a USB port of the first electrical device, a second connector connected with an audio jack of the second electrical device, a cable connecting the first connector and the second connector, and a converting module. The first connector comprises a pair of upper and lower shells and an input/output terminal module mounted on end portions of the shells and electrically connected with the converting module. The converting module is provided for converting data formats between the USB port of the first electrical device and the audio jack of the second electrical device.

The converting module is arranged in a accepting space which is formed of the upper and lower shells, which simplifies the manufacture process, reduces the manufacture cost, and also facilitates the use of the cable assembly. Furthermore, the second connector of the cable assembly according to the present invention is an audio plug, which meets the needs of some new types of mobile phones with special requirements of data transmission through an audio jack.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view of a cable assembly according to a preferred embodiment of the present invention.

FIG. 2 is an exploded view of a first connector of the cable assembly of FIG. 1.

FIG. 3 is a schematic diagram depicting relationships among the cable assembly of FIG. 1, a first electrical device and a second electrical device.

### DETAILED DESCRIPTION OF THE INVENTION

Reference will now be made in detail to a preferred embodiment of the present invention.

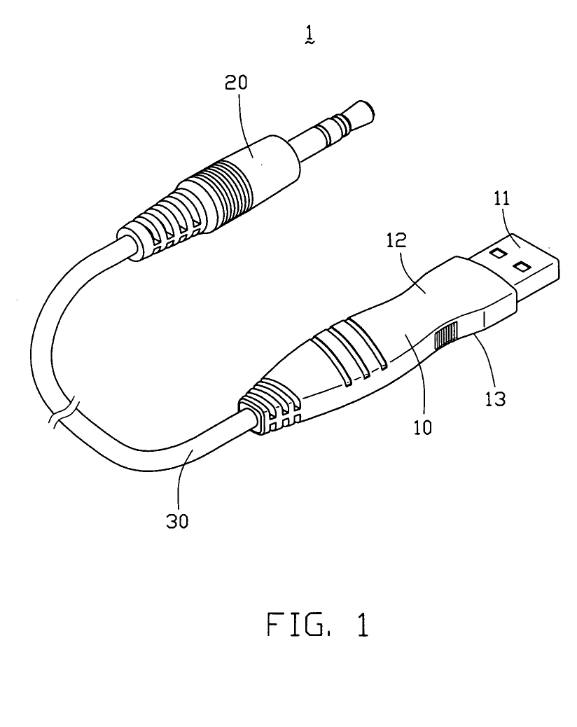

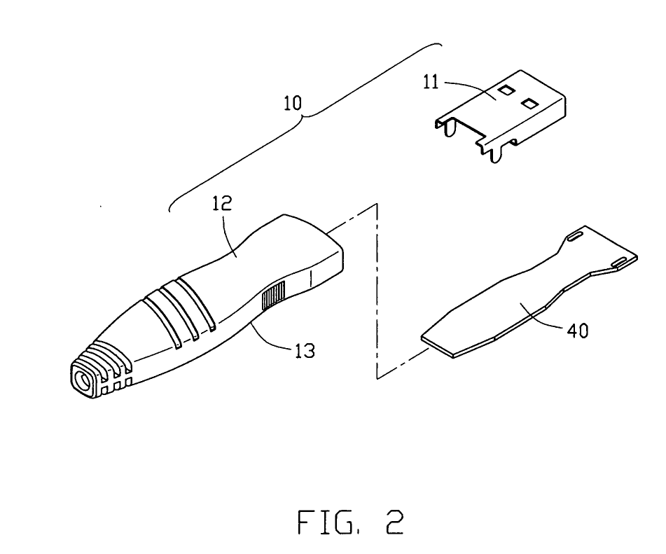

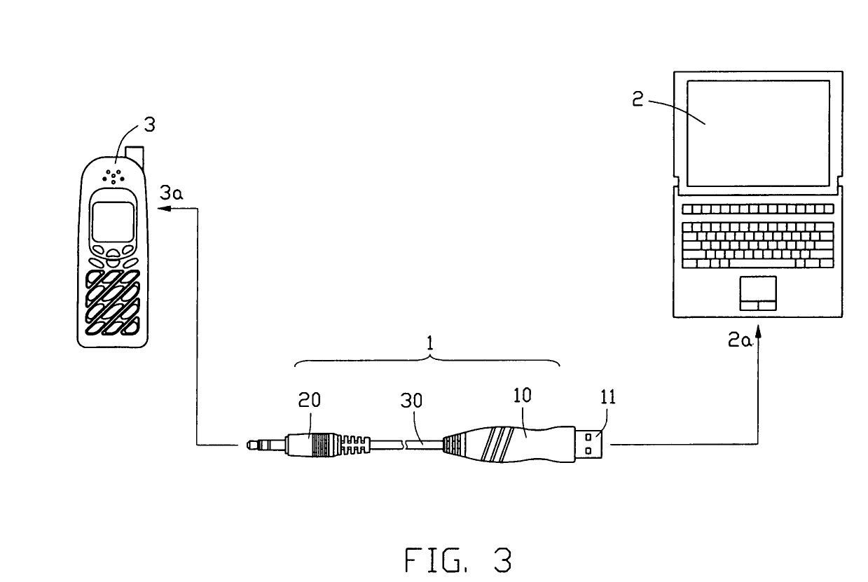

Referring to FIGS. 1-3, a cable assembly 1 according to the preferred embodiment of the present invention is provided for data transmission between a first electrical device and a second electrical device and comprises a first connector 10, a second connector 20, a cable 30 connecting the first connector 10 and the second connector 20, and a converting module 40 arranged in the first connector 10.

In this preferred embodiment, the first electrical device is a personal computer (PC) 2 having a USB port 2a and the second electrical device is a mobile phone 3 having an audio jack 3a.

The first connector 10 is a USB connector in this preferred embodiment and comprises an elongate hollow case (not labeled) and an input/output terminal module 11 comprising four terminals (not shown). The case comprises a pair of upper and lower shells 12 and 13 mounted together and cooperatively defining an accepting space (not labeled) for accepting the converting module 40. The input/output terminal module 11 is partially retained by end portions of the shells 12 and 13.

The second connector 20 is an audio plug in this preferred embodiment of the present invention and electrically connects the first connector 10 through the cable 30 for data transmission.

The converting module 40 is received in the accepting space which is defined by the upper and lower shells 12 and 13. The converting module 40 comprises a front end electrically connecting the second connector 20 through the cable 30 and an opposite rear end electrically connecting the input/output terminal module 11 of the first connector 10. The converting module 40 is provided for converting data formats between the USB port 2a of the personal computer 2 and the audio jack 3a of the mobile phone 3.

The cable assembly 1 can implement double-direction data transmission both from the PC 2 to the mobile phone 3 and from the mobile phone 3 to the PC 2. In use, the input/output terminal module 11 of the first connector 10 mates with the corresponding USB port 2a of the PC 2, and the second connector 20 mates with the audio jack 3a of the mobile phone 3. If USB data are transmitted from the PC 2 to the mobile phone 3, the converting module 40 converts the USB data into serial signals which can be identified by the audio jack 3a of the mobile phone 3. The serial signals are transported to the second connector 20 through the cable 30, then into the audio jack 3a of the mobile phone 3. If serial signals are transmitted from the audio jack 3a of the mobile phone 3 to the PC 2, the converting module 40 converts the serial signals, which are transported to the first connector 10 through the cable 30, into USB data which can be identified by the PC 2.

Alternatively, the cable assembly 1 of the present invention can be connected with a desktop computer, a notebook computer or any electrical device having a USB port for data transmission.

The converting module 40 is arranged in the accepting space which is formed of the upper and lower shells 12 and 13, which simplifies the manufacture process, reduces the manufacture cost, and also facilitates the use of the cable assembly 1. Furthermore, according to the preferred embodiment of the present invention, the second connector 20 of the cable assembly 1 is an audio plug, which meets the needs of some new types of mobile phones with special requirements of data transmission through an audio jack.

Although the invention has been described in its preferred form with a certain degree of particularity, it is understood that the present disclosure of the preferred form has been changed in the details of construction and the combination and arrangement of parts may be resorted to without departing from the scope of the invention as hereinafter claimed.

1. A cable assembly adapted for data transmission between a first electrical device having a Universal Serial Bus port and a second electrical device having an audio jack, comprising:
a first connector comprising a case, and an input/output terminal module retained by the case for connecting with the USB port of the first electrical device;
a second connector for connecting with the second electrical device; a cable connecting the first connector and the second connector; and
a converting module being received in said case and electrically connecting with the input/output terminal module for converting data formats between the first electrical device and the second electrical device.

2. The cable assembly as claimed in claim 1, wherein the second connector is an audio plug for mating with the audio jack of the second electrical device.

3. The cable assembly as claimed in claim 1, wherein the case comprises a pair of upper and lower shells.

4. A cable assembly adapted for data transmission between a first electrical device having a USB port and a second electrical device having an audio jack, comprising:
a first connector for connecting with the USB port of the first electrical device;
a second connector for connecting with the audio jack of the second electrical device;
a cable connecting the first connector and the second connector; and
a converting module, which is situated between and electrically connected with said first connector and said second connector for converting data formats between the USB port of the first electrical device and the audio jack of the second electrical device.

5. The cable assembly as claimed in claim 4, wherein the first connector comprises a case and an input/output terminal module, the case comprising a pair of upper and lower shells defining a space therebetween for accepting the converting module, the input/output terminal module being retained by the shells.

6. An electrical assembly comprising:
a computer defining an I/O port;
a mobile phone defining an audio jack; and
a cable assembly defining at one end an I/O connection port matable to said USB port, at an opposite end an audio plug matable to the audio jack, and a conversion module located between said two ends and converting signals between the computer and the mobile phone.

7. The electrical assembly as claimed in claim 6, wherein said I/O connection port and said I/O port are of a Universal Serial Bus configuration.
